(19) United States
(12) Patent Application Publication
(10) Pub. No.: US 2023/0092878 A1
(43) Pub. Date: Mar. 23, 2023

(54) CONTROL DEVICE AND VEHICLE

(71) Applicant: Isuzu Motors Limited, Tokyo (JP)

(72) Inventors: Yoshitaka KANDA, Fujisawa-shi, Kanagawa (JP); Masaichi TAKAHASHI, Fujisawa-shi, Kanagawa (JP)

(73) Assignee: Isuzu Motors Limited, Tokyo (JP)

(21) Appl. No.: 17/801,801

(22) PCT Filed: Feb. 26, 2021
(86) PCT No.: PCT/JP2021/007559

§ 371 Date: Aug. 24, 2022

(30) Foreign Application Priority Data
Feb. 28, 2020 (JP) 2020-034025

(51) Int. Cl. B60W 30/14; B60W 10/06

(52) U.S. Cl. CPC B60W 30/143; B60W 10/06; B60W 2520/105; B60W 2510/0638

(57) ABSTRACT

Provided are a control device and a vehicle with which rapid and accurate downshifting for maintaining a target vehicle speed can be executed. A control device which is for a vehicle having an automatic transmission that changes the speed for a rotation torque of a drive source using transmission gear ratios of a plurality of travel stages and outputs same to the wheel side, and which executes an auto-cruise travel control for causing the vehicle to travel while maintaining a prescribed speed, the control device being provided with a calculation unit for calculating a decelerated travel stage, which is a travel stage for reducing the current vehicle speed when downshifting from the current travel stage in a condition in which the auto-cruise travel control is being executed and a control for accelerating the vehicle is not being executed while the vehicle speed is increasing.

### TECHNICAL FIELD

The present disclosure relates to a control device and a vehicle.

### BACKGROUND ART

For example, a cruise control is known in which a vehicle speed set by a driver or a vehicle speed determined based on an external factor or externally obtained data is set as a target speed, and the vehicle is caused to travel (auto-cruise travel) while maintaining the target speed. In the cruise control, the rotation speed of a drive source (e.g., internal combustion engine) or a travel stage of an automatic transmission is controlled.

For example, PTL 1 discloses that, when the vehicle speed exceeds the target speed by a prescribed value, a brake actuator is actuated, and, when the acceleration of the vehicle becomes a prescribed value or less by the actuation of the brake actuator, downshifting of the transmission is allowed. Thus, since the shift shock at the time of downshifting is reduced, the driver does not feel uncomfortable, for example.

In addition, for example, PTL 2 discloses that, if the driver wishes to perform sudden acceleration in a case in which the deviation between the vehicle speed and the target vehicle speed is large, downshifting of the transmission is executed.

### CITATION LIST

### Patent Literature

PTL 1

Japanese Patent Application Laid-Open No. 2001-341546

PTL 2

Japanese Patent Application Laid-Open No. H08-067170

### SUMMARY OF INVENTION

### Technical Problem

If a response to an increase in the speed of a vehicle is delayed during auto-cruise travel, a speed exceeding a legally permitted speed or a decrease in the speed by the driver depressing a brake pedal may cause inconvenience such as releasing of the auto-cruise travel.

With the technique described in PTL 1, for the purpose of reducing the shift shock at the time of downshifting, when the acceleration of the vehicle speed becomes the prescribed value or less due to the actuation of the brake actuator, the downshifting is executed via a step of allowing the downshifting. Thus, it is not always possible to execute rapid downshifting for maintaining the target vehicle speed.

The downshifting described in PTL 2 is downshifting for the driver to perform sudden acceleration and is not downshifting for maintaining the target vehicle speed. Thus, it is not always possible to execute accurate downshifting for maintaining the target vehicle speed.

An object of the present disclosure is to provide a control device and a vehicle with which rapid and accurate downshifting for maintaining the target vehicle speed can be executed.

### Solution to Problem

A control device of the present disclosure is a device for a vehicle including an automatic transmission that changes a rotation torque of a drive source using a transmission gear ratio of a plurality of travel stages and outputs the changed rotation torque to a wheel side, the control device being a control device that executes, in the vehicle, an auto-cruise travel control for causing the vehicle to travel while maintaining a prescribed vehicle speed, the control device including:

a calculation section that calculates a deceleration travel stage to reduce a current vehicle speed, the deceleration travel stage being a travel stage that is downshifted from a current travel stage, in a case in which the auto-cruise travel control is being executed, in which a control for accelerating the vehicle is not being executed, and in which the vehicle speed is increasing.

A vehicle of the present disclosure is a vehicle including the control device described above.

### Advantageous Effects of Invention

According to the present disclosure, it is possible to execute rapid and accurate downshifting for maintaining the target vehicle speed.

### BRIEF DESCRIPTION OF DRAWINGS

FIG. 1 is a functional block diagram of a control device according to an embodiment of the present disclosure;

FIG. 2A is a diagram illustrating an example of a case in which a speed increases when a stage is lowered by one;

FIG. 2B is a diagram illustrating an example of a case in which the speed decreases when the stage is lowered by one;

FIG. 2C is a diagram illustrating an example of a case in which the speed decreases when the stage is lowered by one;

FIG. 2D is a diagram illustrating an example of a case in which the speed increases even when the stage is lowered by two; and

FIG. 3 is a flowchart illustrating an example of a downshifting process performed by the control device.

### DESCRIPTION OF EMBODIMENTS

Now, an embodiment of the present disclosure will be described with reference to the drawings.

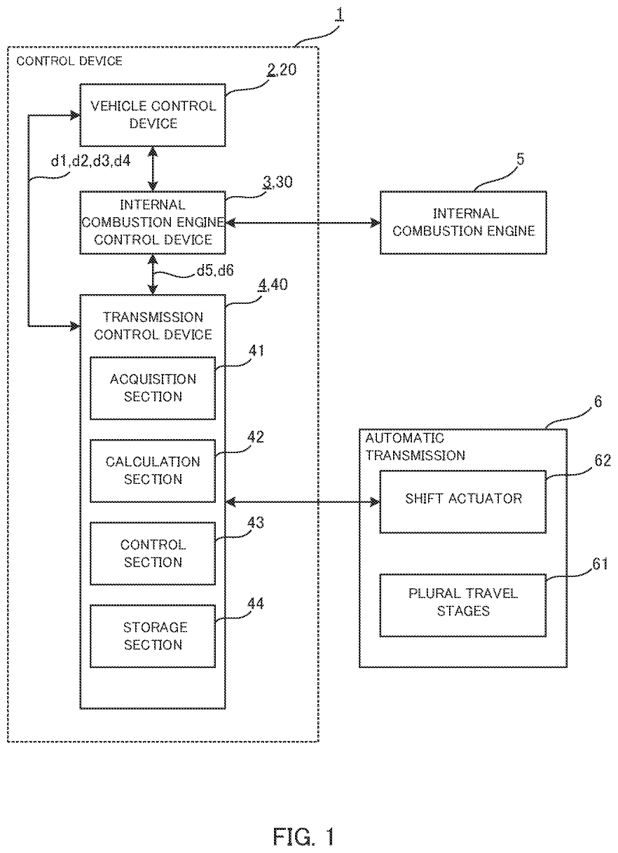

FIG. 1 is a functional block diagram of control device 1 for a vehicle according to the embodiment of the present disclosure. Control device 1 according to this embodiment executes an auto-cruise travel control for causing the vehicle to travel while maintaining a prescribed vehicle speed.

Note that in this embodiment, a drive source installed in the vehicle is internal combustion engine 5. Internal combustion engine 5 is a gasoline engine or a diesel engine using hydrocarbon fuel such as gasoline or diesel oil, and outputs a rotation torque. The rotation torque is transmitted to a drive shaft. A rotation speed sensor (not illustrated) that detects the rotation speed of internal combustion engine 5 is disposed in internal combustion engine 5.

Automatic transmission 6 changes the rotation torque of internal combustion engine 5 using a transmission gear ratio of a plurality of travel stages and outputs the changed rotation torque to the wheel side. Automatic transmission 6 includes plural travel stages 61 configured by a drive gear and a driven gear engaging with each other, and shift actuator 62 that drives each of plural travel stages 61. Shift actuator 62 is controlled by transmission ECU (Electronic Control Unit) 40.

Control device 1 includes vehicle control device 2, internal combustion engine control device 3, and transmission control device 4.

Vehicle control device 2 includes, for example, electronic control unit 20 for a vehicle (vehicle ECU). Vehicle ECU 20 has a CPU (Central Processing Unit), a RAM (Random Access Memory), a ROM (Read Only Memory), an input device, and an output device. Vehicle ECU 20 controls engine ECU 30 and transmission ECU 40. Note that information is exchanged between vehicle ECU 20, engine ECU 30, and transmission ECU 40 by CAN (Controller Area Network) data communication.

Internal combustion engine control device 3 includes, for example, electronic control unit 30 for an engine (engine ECU). Engine ECU 30 has a CPU, a RAM, a ROM, an input device, and an output device. Engine ECU 30 controls a fuel injection device (not illustrated) and a throttle valve (not illustrated). Engine ECU 30 receives the rotation speed of internal combustion engine 5 from the rotation speed sensor.

Transmission control device 4 includes, for example, electronic control unit 40 for a transmission (transmission ECU). Transmission ECU 40 has a CPU, a RAM, a ROM, an input device, and an output device. Transmission ECU 40 has functions of speed change control device 4 such as acquisition section 41, calculation section 42, control section 43, and storage section 44. Transmission ECU 40 receives information d5 and information d6 from engine ECU 30. Information d5 (fuel injection device control information and throttle valve control information) indicates whether a control for accelerating the vehicle is being executed. Information d6 indicates the rotation speed of internal combustion engine 5.

Storage section 44 stores a friction characteristic map and an auxiliary brake characteristic map. The friction characteristic map illustrates a relationship of friction with respect to the rotation speed of internal combustion engine 5. The auxiliary brake characteristic map illustrates a relationship of an auxiliary braking force with respect to the rotation speed of internal combustion engine 5. In general, the friction increases with the rotation speed of internal combustion engine 5. Furthermore, the auxiliary brake herein refers to a compression release engine brake that uses energy for compression by sucking air into cylinders of the internal combustion engine, compressing it, and then exhausting it as it is without doing anything (for example, without injecting fuel). Storage section 44 further stores the reduction ratio, the final ratio, and the tire diameter at the travel stages.

Acquisition section 41 acquires information d1 and information d2 from vehicle ECU 20. Information d1 indicates the weight of the vehicle. Information d2 indicates the acceleration of the vehicle. Note that acquisition section 41 may also acquire the acceleration of the vehicle from an acceleration sensor (not illustrated). Acquisition section 41 further acquires information d3 and information d4 from vehicle ECU 20. Information d3 indicates whether the auto-cruise travel control is being executed. Information d4 indicates whether an actual vehicle speed exceeds the target vehicle speed by a prescribed amount. Acquisition section 41 further acquires information d5 and information d6 from engine ECU 30. Information d5 (fuel injection device control information and throttle valve control information) indicates whether the control for accelerating the vehicle is being executed. Information d6 indicates the rotation speed of internal combustion engine 5.

Based on information d2 to information d5, control section 43 determines whether the auto-cruise travel control is being executed, whether the actual vehicle speed exceeds the target vehicle speed by the prescribed amount, whether the control for accelerating the vehicle is not being executed, and whether the vehicle speed is increasing.

If the auto-cruise travel control is being executed, the actual vehicle speed exceeds the target vehicle speed by the prescribed amount, the control for accelerating the vehicle is not being executed, and the vehicle speed is increasing, calculation section 42 calculates the acceleration of the vehicle at a travel stage that is downshifted from the current travel stage.

From the friction output characteristic map, calculation section 42 obtains the frictional resistance of internal combustion engine 5 based on the rotation speed of internal combustion engine 5. From the auxiliary brake characteristic map, calculation section 42 also obtains the braking force of the auxiliary brake based on the rotation speed of internal combustion engine 5.

Based on the frictional resistance of internal combustion engine 5, the braking force of the auxiliary brake, information d1 indicating the weight of the vehicle, information d2 indicating the acceleration of the vehicle, and the reduction ratio, the final ratio, and the tire diameter at the travel stages, calculation section 42 calculates a travel resistance equivalent torque (torque for accelerating the vehicle).

From the rotation speed of internal combustion engine 5, the reduction ratio at the current travel stage, and the reduction ratio at a travel stage that is one stage lower, calculation section 42 obtains the rotation speed of internal combustion engine 5 at the travel stage that is one stage lower.

From the friction output characteristic map of internal combustion engine 5, calculation section 42 obtains the frictional resistance based on the rotation speed of internal combustion engine 5 at the travel stage that is one stage lower. In addition, from the friction output characteristic map, calculation section 42 obtains the braking force of the auxiliary brake based on the rotation speed of internal combustion engine 5 at the travel stage that is one stage lower, and by combining the frictional resistance and the braking force of the auxiliary brake, obtains a braking torque of internal combustion engine 5 at the travel stage that is one stage lower (torque to decelerate the vehicle).

Based on the obtained braking torque of internal combustion engine 5 and the obtained travel resistance equivalent torque (torque for accelerating the vehicle), calculation section 42 calculates the acceleration of the vehicle at the travel stage that is one stage lower than the current travel stage.

Specifically, calculation section 42 multiplies or divides a subtracted value (torque) obtained by subtracting the travel resistance equivalent torque from the braking torque of internal combustion engine 5 by a prescribed parameter (e.g., the reduction ratio at the current travel stage, the reduction ratio, the final ratio, and the tire diameter at the travel stage that is one stage lower, and the weight of the vehicle), thereby calculating the acceleration at the travel stage that is one stage lower.

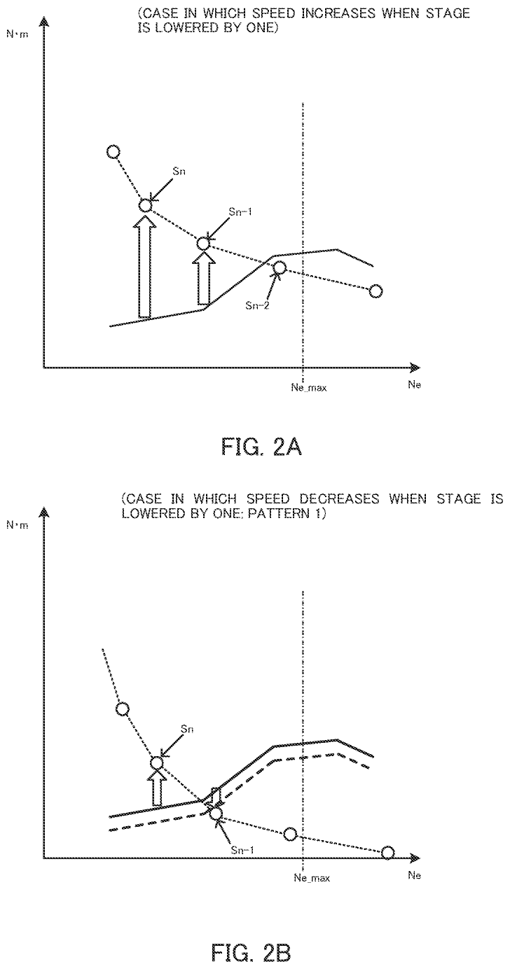

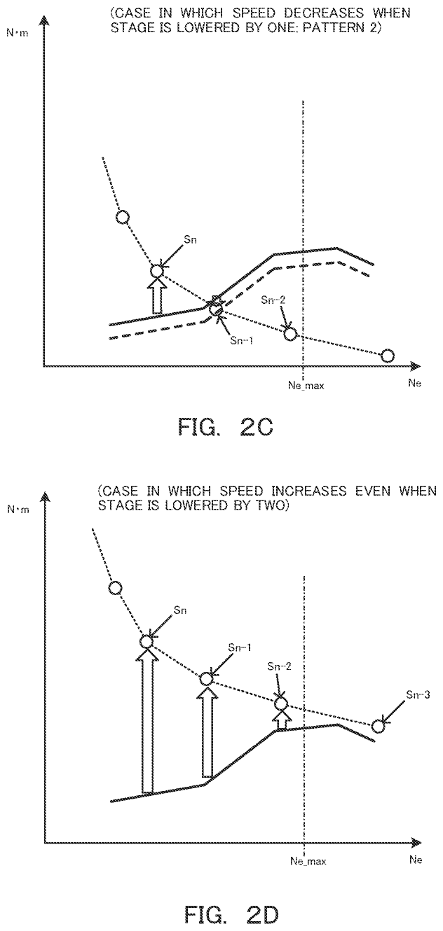

Next, details of calculation section 42 will be described with reference to FIG. 2A to FIG. 2D. FIG. 2A is a diagram illustrating an example of a case in which the speed increases when the stage is lowered by one. In FIG. 2A, the horizontal axis represents the rotation speed (Ne) of internal combustion engine 5, and the vertical axis represents the braking torque (N·m). In FIG. 2A, the solid line indicates the braking torque of internal combustion engine 5, and a circle mark indicates the travel resistance equivalent torque at current travel stage Sn. In addition, in FIG. 2A, circle marks similarly indicate the travel resistance equivalent torque at travel stage Sn−1 that is one stage lower than current travel stage Sn and the travel resistance equivalent torque at travel stage Sn−2 that is one more stage lower.

At current travel stage Sn, the braking torque (torque to decelerate the vehicle) of internal combustion engine 5 is less than the travel resistance equivalent torque (torque for accelerating the vehicle) (indicated by an upward arrow in FIG. 2A). Thus, the vehicle speed exhibits an increase.

Based on the braking torque of internal combustion engine 5 and the travel resistance equivalent torque, calculation section 42 calculates the acceleration of the vehicle at travel stage Sn−1 that is one stage lower than current travel stage Sn. Also at current travel stage Sn−1, the braking torque of internal combustion engine 5 is less than the travel resistance equivalent torque (indicated by an upward arrow in FIG. 2A). Thus, the acceleration calculated by calculation section 42 does not exhibit deceleration. If the calculated acceleration the does not exhibit deceleration, calculation section 42 calculates the acceleration of the vehicle at travel stage Sn−2 that is one more stage lower.

FIG. 2B is a diagram illustrating an example (pattern 1) of a case in which the speed decreases when the stage is lowered by one. At travel stage Sn−1, the braking torque of internal combustion engine 5 is greater than the travel resistance equivalent torque (indicated by the downward arrow in FIG. 2B). The acceleration calculated by calculation section 42 exhibits deceleration.

Calculation section 42 compares the calculated acceleration with a prescribed deceleration. The prescribed deceleration herein is, for example, 0.01*gravitational acceleration (m/s²). In FIG. 2B, the broken line indicates numerical values obtained by converting the prescribed deceleration into torques. The reason why the calculated acceleration is compared with the prescribed deceleration is that the travel stage to decelerate the vehicle is reliably calculated even if a calculation error occurs at the time of calculating the acceleration.

If the calculated acceleration exhibits deceleration and the deceleration is greater than or equal to the prescribed deceleration (FIG. 2B indicates that the deceleration is greater than or equal to the prescribed deceleration), calculation section 42 sets travel stage Sn−1 after downshifting as a deceleration travel stage. In this case, control section 43 controls shift actuator 62 so as to execute downshifting from current travel stage Sn to the deceleration travel stage (travel stage Sn−1).

FIG. 2C is a diagram illustrating an example (pattern 2) of a case in which the speed decreases when the stage is lowered by one. At travel stage Sn−1, the braking torque of internal combustion engine 5 is greater than the travel resistance equivalent torque (indicated by the downward arrow in FIG. 2C). The acceleration calculated by calculation section 42 exhibits deceleration.

Calculation section 42 compares the calculated acceleration with the prescribed deceleration. If the calculated acceleration does not exhibit deceleration, or if the calculated acceleration exhibits deceleration but the deceleration is less than the prescribed deceleration (FIG. 2C illustrates that the deceleration is less than the prescribed deceleration), calculation section 42 calculates the acceleration of the vehicle at travel stage Sn−2 that is one stage lower than travel stage Sn−1 after downshifting.

Calculation section 42 calculates the rotation speed of internal combustion engine 5 in a case in which downshifting to the travel stage is executed, compares the calculated rotation speed with a prescribed maximum rotation speed, and, if the calculated rotation speed is less than or equal to the maximum rotation speed, calculates the acceleration of the vehicle at the travel stage that is downshifted. In other words, if the calculated rotation speed is higher than the maximum rotation speed, calculation section 42 does not calculate the acceleration of the vehicle at the travel stage that is downshifted. Note that since rotation speed Ne of internal combustion engine 5 in a case in which downshifting to the travel stage is executed is less than or equal to maximum rotation speed Ne_max in the examples illustrated in FIG. 2B and FIG. 2C, calculation section 42 calculates the acceleration of the vehicle at the travel stage that is downshifted.

FIG. 2D is a diagram illustrating an example of a case in which the speed increases even when the stage is lowered by two. FIG. 2D illustrates the acceleration of the vehicle at travel stage Sn−2 that is one stage lower than travel stage Sn−1. In addition, maximum rotation speed Ne_max of internal combustion engine 5 after downshifting is illustrated. As indicated by an upward arrow in FIG. 2D, the acceleration of the vehicle at travel stage Sn−2 does not exhibit deceleration.

Calculation section 42 compares rotation speed Ne of internal combustion engine 5 at a travel stage Sn−3 that is one stage lower than travel stage Sn−2 with maximum rotation speed Ne_max of internal combustion engine 5. If calculated rotation speed Ne of internal combustion engine 5 is higher than maximum rotation speed Ne_max of internal combustion engine 5, calculation section 42 does not calculate the acceleration of the vehicle at the travel stage Sn−3 after downshifting. In this case, control section 43 controls shift actuator 62 so as to execute downshifting from current travel stage Sn to travel stage Sn−2.

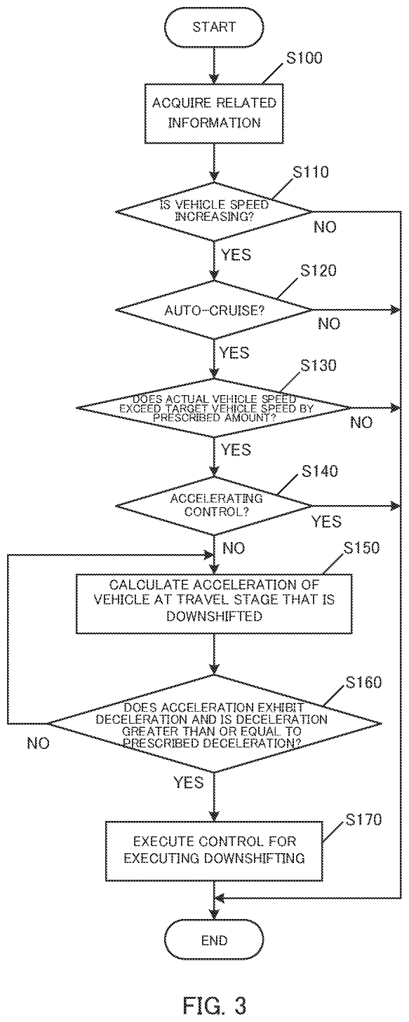

Next, an example of a downshifting process performed by control device 1 will be described with reference to FIG. 3. FIG. 3 is a flowchart illustrating an example of the downshifting process performed by control device 1. The flow illustrated in FIG. 3 starts in response to starting of the engine. In the following description, the downshifting process is performed by transmission ECU 40 having the functions of acquisition section 41, calculation section 42, control section 43, and storage section 44. Note that storage section 44 stores in advance the friction characteristic map and the auxiliary brake characteristic map. The friction characteristic map illustrates a relationship of friction with respect to the rotation speed of internal combustion engine 5. The auxiliary brake characteristic map illustrates a relationship of an auxiliary braking force with respect to the rotation speed of internal combustion engine 5. Note that in the downshifting process illustrated in FIG. 3, calculation section 42 compares the rotation speed of internal combustion engine 5 with the maximum rotation speed of internal combustion engine 5, and based on the comparison result, does not perform a process of calculating the acceleration of the vehicle.

First, in step S100, transmission ECU 40 acquires related information. Specifically, transmission ECU 40 acquires information d1 and information d2 from vehicle ECU 20. Information d1 indicates the weight of the vehicle. Information d2 indicates the acceleration of the vehicle. Transmission ECU 40 further acquires information d3 and information d4 from vehicle ECU 20. Information d3 indicates whether the auto-cruise travel control is being executed. Information d4 indicates whether the actual vehicle speed exceeds the target vehicle speed by the prescribed amount. Transmission ECU 40 further acquires information d5 and information d6 from engine ECU 30. Information d5 indicates whether the control for accelerating the vehicle is being executed. Information d6 indicates rotation speed of internal combustion engine 5.

Subsequently, in step S110, based on information d2, transmission ECU 40 determines whether the vehicle speed is increasing. If the vehicle speed is increasing (step S110: YES), the process transitions to step S120. If the vehicle speed is not increasing (step S110: NO), the process illustrated in FIG. 3 ends.

In step S120, based on information d3, transmission ECU 40 determines whether the auto-cruise travel control is being executed. If the auto-cruise travel control is being executed (step S120: YES), the process transitions to step S130. If the auto-cruise travel control is not being executed (step S120: NO), the process illustrated in FIG. 3 ends.

In step S130, based on information d4, transmission ECU 40 determines whether the actual vehicle speed exceeds the target vehicle speed by the prescribed amount. If the actual vehicle speed exceeds the target vehicle speed by the prescribed amount (step S130: YES), the process transitions to step S140. If the actual vehicle speed does not exceed the target vehicle speed by the prescribed amount (step S130: NO), the process illustrated in FIG. 3 ends.

In step S140, based on information d5, transmission ECU 40 determines whether the control for accelerating the vehicle is being executed. If the control for accelerating the vehicle is not being executed (step S140: NO), the process transitions to step S150. If the control for accelerating the vehicle is being executed (step S140: YES), the process illustrated in FIG. 3 ends.

In step S150, based on information d1 and information d2, referring to the friction output characteristic map, the auxiliary brake characteristic map, and output characteristics of internal combustion engine 5, transmission ECU 40 calculates the acceleration of the vehicle at the travel stage that is downshifted.

Subsequently, in step S160, transmission ECU 40 determines whether the calculated acceleration exhibits deceleration and whether the deceleration is greater than or equal to the prescribed deceleration. If the calculated acceleration exhibits deceleration and the deceleration is greater than or equal to the prescribed deceleration (step S160: YES), the process transitions to step S170. If the calculated acceleration does not exhibit deceleration, or if the calculated acceleration exhibits deceleration but the deceleration is not greater than or equal to the prescribed deceleration (step S160: NO), the process returns to before step S150. In this case, transmission ECU 40 calculates the acceleration of the vehicle at a travel stage that is one stage lower than the travel stage in a case in which the acceleration is calculated in step S150

In step S170, transmission ECU 40 executes a control for executing downshifting from the current travel stage to the deceleration travel stage, which is a travel stage at which the acceleration exhibits deceleration.

Control device 1 according to this embodiment is control device 1 for a vehicle including automatic transmission 6 that changes the rotation torque of internal combustion engine 5 using a transmission gear ratio of a plurality of travel stages and outputs the changed rotation torque to the wheel side. Control device 1 executes, in the vehicle, the auto-cruise travel control for causing the vehicle to travel while maintaining the prescribed vehicle speed. Control device 1 includes calculation section 42 that calculates the deceleration travel stage to reduce the current vehicle speed, the deceleration travel stage being a travel stage that is downshifted from the current travel stage, in a case in which the auto-cruise travel control is being executed, in which a control for accelerating the vehicle is not being executed, and in which the vehicle speed is increasing.

With the above configuration, the travel stage at which deceleration can be performed is calculated, and then, downshifting is executed. This can prevent useless downshifting, such as downshifting to a travel stage at which deceleration cannot be performed. Thus, rapid and accurate downshifting can be executed.

In addition, in control device 1 according to this embodiment, in a case in which the acceleration of the vehicle at the travel stage does not exhibit deceleration, calculation section 42 calculates the acceleration of the vehicle at a travel stage that is one stage lower than the travel stage. Thus, it is possible to efficiently obtain a travel stage exhibiting deceleration.

In addition, in control device 1 according to this embodiment, calculation section 42 sets, as the deceleration travel stage, a travel stage at which the calculated acceleration exhibits deceleration and at which the deceleration is greater than or equal to the prescribed deceleration. Thus, it is possible to calculate the travel stage at which deceleration is reliably performed even if a calculation error occurs at the time of calculating the acceleration.

In addition, in control device 1 according to this embodiment, if the rotation speed of internal combustion engine 5 in a case in which downshifting is executed is less than or equal to the prescribed maximum rotation speed, calculation section 42 calculates the acceleration of the vehicle at the travel stage that is downshifted. Thus, it is possible to decelerate the vehicle while the rotation speed of internal combustion engine 5 is suppressed to be less than or equal to the maximum rotation speed.

The above-described embodiment is merely an example of concretization for carrying out the present disclosure, and the technical scope of the present disclosure should not be interpreted in a manner limited thereby. That is, the present disclosure can be carried out in various forms without deviating from the gist or main features of the present disclosure.

Note that in the above-described embodiment, based on the frictional resistance of internal combustion engine 5, the braking force of the auxiliary brake, information d1 indicating the weight of the vehicle, information d2 indicating the acceleration of the vehicle, and the reduction ratio, the final ratio, and the tire diameter at the travel stages, calculation section 42 calculates the travel resistance equivalent torque (torque to accelerate the vehicle). However, the present disclosure is not limited to this, and the torque to accelerate the vehicle may also be obtained by a known method. For example, based on map data (slope of road on which the vehicle travels), the rolling resistance of tires, the air resistance of the vehicle, or the like, calculation section 42 may obtain the torque to accelerate the vehicle.

In addition, in the above-described embodiment, based on the braking torque (N·m) of internal combustion engine 5, calculation section 42 calculates the acceleration of the vehicle at the travel stage that is one stage lower than current travel stage. However, the present disclosure is not limited to this. For example, the calculation may also be performed based on the braking force (kg·m/s²) of internal combustion engine 5.

Furthermore, in the above-described embodiment, in a case in which the above prescribed conditions are satisfied in the auto-cruise travel, transmission ECU 40 controls shift actuator 62 so as to execute downshifting. Without limitation to this, even during the auto-cruise travel or not during the auto-cruise travel, transmission ECU 40 may also control shift actuator 62 so as to automatically switch the transmission gear ratio in accordance with the vehicle speed or information d6 indicating the rotation speed of internal combustion engine 5.

This application is based on Japanese Patent Application No. 2020-034025 filed on Feb. 28, 2020, which is incorporated herein by reference in its entirety.

### INDUSTRIAL APPLICABILITY

The present disclosure is suitably used for a vehicle including a control device that is required to execute rapid and accurate downshifting for maintaining a target vehicle speed.

### REFERENCE SIGNS LIST

1 Control device

2 Vehicle control device

3 Internal combustion engine control device

4 Transmission control device

5 Internal combustion engine

6 Automatic transmission

20 Vehicle ECU

30 Engine ECU

40 Transmission ECU

41 Acquisition section

42 Calculation section

43 Control section

44 Storage section

61 Travel stage

62 Shift actuator

1. A control device for a vehicle including an automatic transmission that changes a rotation torque of a drive source using a transmission gear ratio of a plurality of travel stages and outputs the changed rotation torque to a wheel side, the control device being a control device that executes, in the vehicle, an auto-cruise travel control for causing the vehicle to travel while maintaining a prescribed vehicle speed, the control device comprising:
a calculation section that calculates a deceleration travel stage to reduce a current vehicle speed, the deceleration travel stage being a travel stage that is downshifted from a current travel stage, in a case in which the auto-cruise travel control is being executed, in which a control for accelerating the vehicle is not being executed, and in which the vehicle speed is increasing.

2. The control device according to claim 1, wherein:
based on a force to accelerate the vehicle and a force to decelerate the vehicle, the calculation section calculates an acceleration of the vehicle at the travel stage that is downshifted and sets, as the deceleration travel stage, a travel stage at which the calculated acceleration exhibits deceleration.

3. The control device according to claim 2, wherein:
the calculation section sets, as the deceleration travel stage, a travel stage at which the calculated acceleration exhibits deceleration and at which a deceleration is greater than or equal to a prescribed deceleration.

4. The control device according to claim 3, wherein:
in a case in which the acceleration of the vehicle at the travel stage does not exhibit deceleration or exhibits deceleration but the deceleration is less than the prescribed deceleration, the calculation section calculates the acceleration of the vehicle at a travel stage that is one stage lower than the travel stage.

5. The control device according to claim 2, wherein:
the calculation section calculates a rotation speed of the drive source in a case in which downshifting to the travel stage is executed, and when the calculated rotation speed is less than or equal to a prescribed maximum rotation speed, the calculation section calculates the acceleration of the vehicle at the travel stage that is downshifted.

6. The control device according to claim 1, comprising:
a control section that executes a control for executing downshifting from the current travel stage to the deceleration travel stage.

7. A vehicle comprising the control device according to claim 1.

8. A vehicle comprising the control device according to claim 2.

9. A vehicle comprising the control device according to claim 3.

10. A vehicle comprising the control device according to claim 4.

11. A vehicle comprising the control device according to claim 5.

12. A vehicle comprising the control device according to claim 6.
